(19) United States
(12) Patent Application Publication
(10) Pub. No.: US 2011/0016521 A1
(43) Pub. Date: Jan. 20, 2011

(54) INFORMATION PROCESSING METHOD, COMPUTER READABLE MEDIUM, AND INFORMATION PROCESSING APPARATUS

(75) Inventor: Kenichiro KIGO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/702,392

(22) Filed: Feb. 9, 2010

(30) Foreign Application Priority Data
Jul. 17, 2009 (JP) 2009-169519

(51) Int. Cl. G06F 21/00

(52) U.S. Cl. 726/19

(57) ABSTRACT

According to an aspect of the invention, a computer readable medium stores a program causing a computer to perform a process. In the program, the process includes receiving an instruction from a user, determining a rule based on a strength of authentication information of the user, and executing information processing according to the received instruction and the determined rule.

### CROSS-REFERENCE TO RELATED APPLICATIONS

This application is based upon and claims priority under 35 USC 119 from Japanese Patent Application No. 2009-169519, filed Jul. 7, 2009.

### BACKGROUND

1. Technical Field

The present invention relates to an information processing method, a computer readable medium, and an information processing apparatus.

2. Related Art

There is a system which manages the authentication information of a password or the like. Moreover, there is a system which manages a rule regarding a password, for example, the expiration date of a password.

### SUMMARY OF THE INVENTION

According to an aspect of the invention, a computer readable medium stores a program causing a computer system to perform as an information processing execution module. The information processing execution module executes information processing according to a rule determined based on a strength of authentication information which is stored in a storage unit associated with an identifier of a user.

### BRIEF DESCRIPTION OF THE DRAWINGS

Exemplary embodiments of the invention will be described in detail based on the following figures, wherein:

FIG. 1 is a view showing an example of the configuration of an information processing system according to an exemplary embodiment of the invention;

FIG. 2 is a view showing an example of the hardware configuration of an information processing apparatus according to the exemplary embodiment of the invention;

FIG. 3 is a functional block diagram showing an example of a function realized by the information processing apparatus according to the exemplary embodiment of the invention;

FIG. 4 is a view showing an example of data structure of user information;

FIG. 5 is a view showing an example of data structure of renewal history information;

FIG. 6 is a flow chart showing an example of the flow of processing performed in the information processing system according to the exemplary embodiment; and

FIG. 7 is a flow chart showing an example of the flow of processing performed in the information processing system according to the exemplary embodiment.

### DETAILED DESCRIPTION

Hereinafter, an exemplary embodiment of the invention will be described in detail with reference to the accompanying drawings.

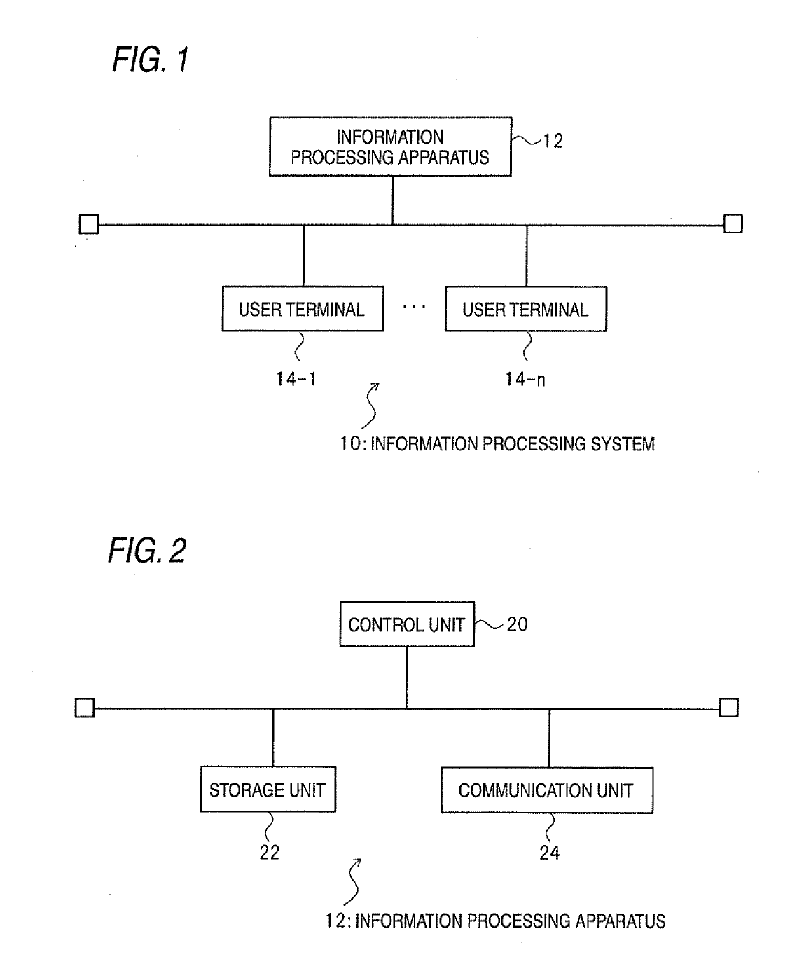

FIG. 1 is a view showing an example of the configuration of an information processing system 10 according to the exemplary embodiment. As shown in FIG. 1, the information processing system 10 according to the exemplary embodiment is configured to include an information processing apparatus 12 which functions as a server and a user terminal (client) 14 (14-1 to 14-n). The information processing apparatus 12 and the user terminal 14 are connected to a communication means, such as a LAN or the Internet, so that they can communicate with each other.

The user terminal 14 illustrated in FIG. 1 is formed by a known personal computer including a control device such as a CPU, a storage device such as a hard disk, an output device such as a display, an input device such as a keyboard or a mouse, and a communication device such as a LAN card, for example.

FIG. 2 is a view showing an example of the hardware configuration of the information processing apparatus 12 according to the exemplary embodiment. As illustrated in FIG. 2, the information processing apparatus 12 according to the exemplary embodiment includes a control unit 20, a storage unit 22, and a communication unit 24, for example. These components are connected to each other through a bus. The control unit 20 is a program control device, such as a CPU, and operates according to a program installed in the information processing apparatus 12. The storage unit 22 is a storage device, such as a ROM or a RAM, or a hard disk. A program executed by the control unit 20 is stored in the storage unit 22. In addition, the storage unit 22 also operates as a work memory of the control unit 20. The communication unit 24 is a communication interface, such as a LAN card, and transmits the information to the user terminal 14 or receives the information from the user terminal 14.

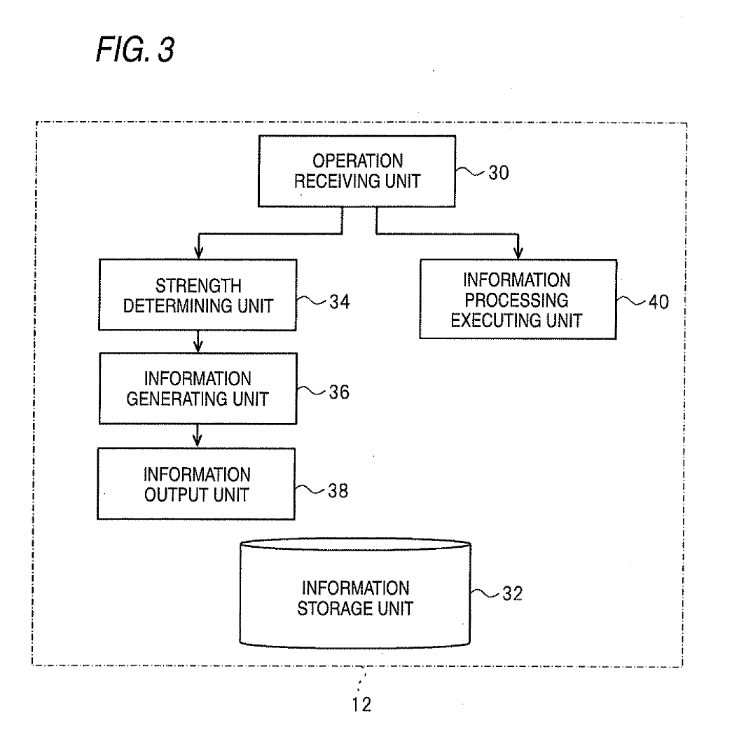

FIG. 3 is a functional block diagram showing an example of the function realized by the information processing apparatus 12 according to the exemplary embodiment. As illustrated in FIG. 3, in the exemplary embodiment, the information processing apparatus 12 includes an operation receiving unit 30, an information storage unit 32, a strength determining unit 34, an information generating unit 36, an information output unit 38, and an information processing executing unit 40, for example. The information storage unit 32 is mainly realized by the storage unit 22. The other components are mainly realized by the control unit 20.

These components are realized by causing the control unit 20 of the information processing apparatus 12 to execute a program installed in the information processing apparatus 12 which is a computer. For example, this program is supplied to the information processing apparatus 12 through computer-readable information transmission media, such as a CD-ROM or a DVD-ROM, or a communication means, such as the Internet.

The operation receiving unit 30 receives the contents of user's instruction. In the exemplary embodiment, the operation receiving unit 30 receives a user's operation, for example. Specifically, for example, when the user operates a keyboard, a mouse, or the like provided in the user terminal 14, the user terminal 14 outputs the operation signal to the information processing apparatus 12. Then, the operation receiving unit 30 of the information processing apparatus 12 receives the operation signal.

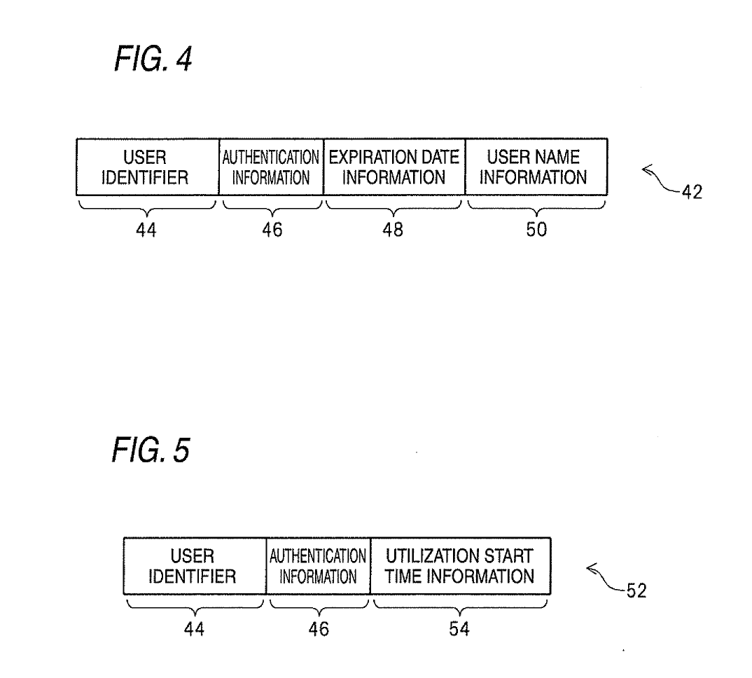

The information storage unit 32 stores the information, such as user information 42 illustrated in FIG. 4, for example. FIG. 4 is a view showing an example of the data structure of the user information 42. As illustrated in FIG. 4, the user information 42 includes a user identifier (user ID) 44 which is an identifier of a user of the information processing system 10, authentication information 46 (specifically, for example, a character string such as a password or a token, certificate information, or information corresponding to the features of the user such as a face, a fingerprint, or a vein) of the user, expiration date information 48 indicating the expiration date of the authentication information 46, and user name information 50 indicating the name of the user, for example. In the exemplary embodiment, the information storage unit 32 stores at least one item of the user information 42 beforehand. Thus, in the exemplary embodiment, the user identifier 44 and the authentication information 46 are associated with each other.

In addition, the information storage unit 32 stores renewal history information 52 illustrated in FIG. 5, for example. FIG. 5 is a view showing an example of the data structure of the renewal history information 52. As illustrated in FIG. 5, the renewal history information 52 includes a user identifier 44, authentication information 46, and utilization start time information 54 indicating the time (for example, registered date and time) when the use of the authentication information 46 was started, for example. In addition, the information storage unit 32 may store the user master information indicating the correspondence relationship between the user identifier 44 and the user name information 50, for example.

The strength determining unit 34 determines the strength of the authentication information 46. Details of the strength of the authentication information 46 will be described later.

The information generating unit 36 generates the information output to the information storage unit 32, for example. The information generating unit 36 generates the rule-corresponding information which corresponds to the rule for controlling the information processing of the information processing executing unit 40 to be described later, for example. In the exemplary embodiment, the information generating unit 36 generates the expiration date information 48 or the renewal history information 52, for example.

The information output unit 38 outputs the information, such as the user information 42, to the information storage unit 32. Specifically, the information output unit 38 outputs (additional output or update output) the user information 42 to the information storage unit 32 according to a registration operation (new registration operation or renewal registration operation) of the user information 42 received from a user, for example. In addition, the information output unit 38 deletes the user information 42, which is stored in the information storage unit 32, according to a deleting operation of the user information 42, for example. In addition, the information generating unit 36 may generate the renewal history information 52 according to the registration operation of the user information 42. In addition, the information output unit 38 may output the renewal history information 52 to the information storage unit 32.

The information processing executing unit 40 executes information processing using the authentication information 46. For example, the information processing executing unit 40 executes authentication processing (authentication result output processing) for outputting the authentication result information indicating an authentication result, such as success or failure of the authentication, on the basis of a comparison result of the authentication information 46 received from the user and the authentication information 46 stored in the information storage unit 32 associated with the user identifier 44 of the user. In addition, the information processing executing unit 40 may execute authentication processing on a request for login to the operating system or authentication processing on a request for login to the business application program, for example.

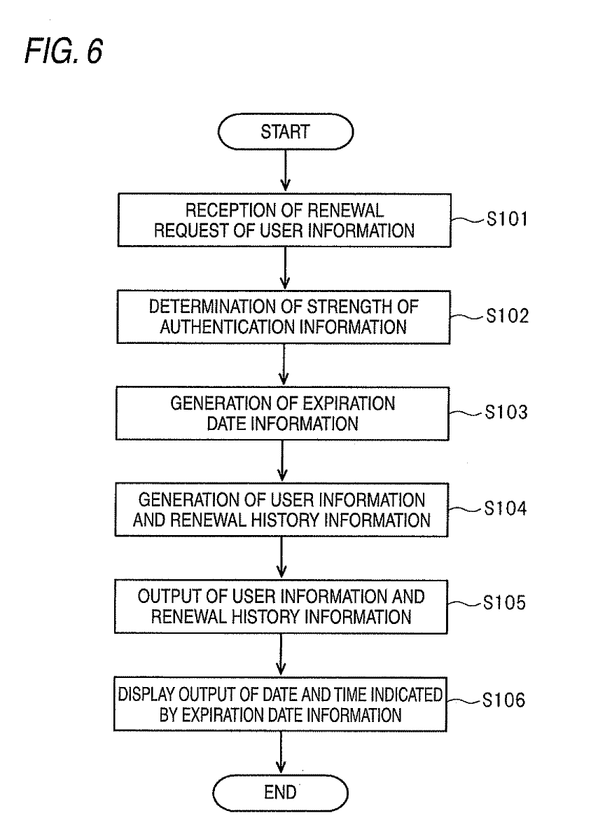

Here, an example of the flow of update processing of the user information 42 performed in the information processing system 10 according to the exemplary embodiment will be described with reference to the flow chart illustrated in FIG. 6.

First, the operation receiving unit 30 receives a renewal request of the user information 42 including the user identifier 44 and the authentication information 46 from the user terminal 14, for example (S101). Then, the strength determining unit 34 determines the strength of the authentication information 46 on the basis of the authentication information 46 received in the processing illustrated in S101 (S102). Specifically, the information generating unit 36 determines the strength represented by a numeric value of 0 to 10, on the basis of length of a character string (authentication character string) of the authentication information 46, character type (capital letter, lowercase letter, or existence of a number or symbol) of the authentication character string, and the like, for example.

Moreover, for example, the strength determining unit 34 may specify the past authentication information 46 registered by the user on the basis of the renewal history information 52, which includes the user identifier 44 received in the processing illustrated in S101, and determine the strength on the basis of a difference (for example, the similarity or discrepancy of character strings determined according to the standard defined beforehand) between the specified past authentication information 46 and the authentication information 46 received in the processing illustrated in S101. In addition, the strength determining unit 34 may determine the strength such that the value of the strength decreases as the difference decreases.

In addition, the strength determining unit 34 may specify the authentication information 46, which is most similar to the authentication information 46 received in the processing illustrated in S101, among the past authentication information 46. Then the strength determining unit 34 may determine the strength on the basis of elapsed time to the present from a time when the specified authentication information 46 is used. In addition, the strength determining unit 34 may determine the strength such that the value of the strength decreases as the elapsed time becomes short.

In addition, the strength determining unit 34 may determine the strength on the basis of a period from a time when the authentication information 46 is lastly renewed to the present, for example. The strength determining unit 34 may determine the strength such that the value of the strength decreases as the period becomes short, for example. In addition, for example, when the authentication information 46 is certificate information, the strength determining unit 34 may determine the strength on the basis of the number of bits of the certificate information, the strength of a key, an expiration date, a period until the expiration date, and the like.

In addition, when the information in a word dictionary is stored beforehand in the information storage unit 32, the strength determining unit 34 may determine the strength based on whether a word corresponding to (for example, similar to) the received authentication information 46 exists in the word dictionary. For example, the strength determining unit 34 may determine the strength such that the value of the strength decreases when a word included in the authentication information 46 exists in the word dictionary.

Then, the information generating unit 36 generates the expiration date information 48 indicating the expiration date of the authentication information 46 based on current date and time and the expiration date corresponding to the strength determined in the processing illustrated in S102 (S103). In the exemplary embodiment, strength and effective term correspondence information in which the strength and the effective term are correlated with each other (for example, the effective term becomes longer as the value of the strength gets larger) is stored beforehand in the information storage unit 32, for example. The information generating unit 36 generates the expiration date information 48, which indicates the date and time when the authentication information 46 expires, by adding to the current date and time the effective term determined on the basis of the strength and effective term correspondence information. Thus, in the exemplary embodiment, the information generating unit 36 generates the rule-corresponding information corresponding to the rule determined based on the authentication information 46 stored in the information storage unit 32 so as to be associated with the user identifier 44.

Then, the information generating unit 36 generates the user information 42 including the user identifier 44 included in the registration request received in the processing illustrated in S101, the authentication information 46 included in the registration request received in the processing illustrated in S101, the expiration date information 48 generated by the processing illustrated in S103, and the user name information 50 corresponding to the user identifier 44 and also generates the renewal history information 52 including the user identifier 44 included in the registration request received in the processing illustrated in S101, the authentication information 46 included in the registration request received in the processing illustrated in S101, and the utilization start time information 54 indicating the date and time at which the registration request illustrated in S101 was received. (S104)

Then, the information output unit 38 deletes the user information 42, which is stored in the information storage unit 32 and includes the user identifier 44 received in the processing illustrated in S101, and outputs to the information storage unit 32 the user information 42 generated by the processing illustrated in S104 and also outputs to the information storage unit 32 the renewal history information 52 generated by the processing illustrated in S104 (S105). That is, the information output unit 38 updates the user information 42 stored in the information storage unit 32 and adds the renewal history information 52 in the information storage unit 32.

Then, the information output unit 38 outputs and displays the date and time, which is indicated by the expiration date information 48 generated in the processing illustrated in S103, on an output device such as a display provided in the user terminal 14 (S106).

In addition, when the strength determined in the processing illustrated in S102 is smaller than the value set beforehand or equal to or smaller than the value set beforehand or when the authentication information 46 received in the processing illustrated in S101 is against the policy (rule) defined beforehand, the information output unit 38 may output the information indicating that the registration request is refused to an output device such as a display provided in the user terminal 14.

In addition, the authority information in which the user identifier 44 and the user's authority indicated by the user identifier 44 are associated may be stored beforehand in the information storage unit 32. Moreover, in the processing illustrated in S102, the strength determining unit 34 may determine the strength of the authentication information 46 on the basis of the authentication information 46 received in the processing illustrated in S101 and the authority information associated with the user identifier 44 received in the processing illustrated in S101. In addition, in the processing illustrated in S103, the information generating unit 36 may generate the expiration date information 48 on the basis of the strength of the authentication information 46 determined in the processing illustrated in S102 and the authority information associated with the user identifier 44 received in the processing illustrated in S101.

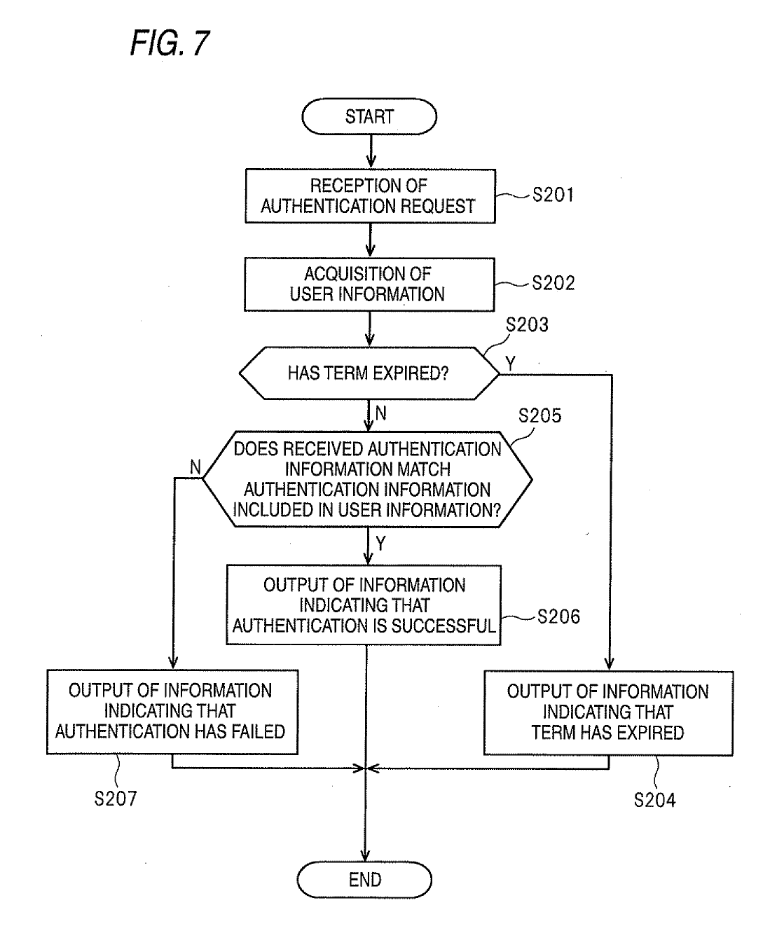

Next, an example of the flow of the processing performed in the information processing system 10 according to the exemplary embodiment, in the case where the information processing executing unit 40 performs the user authentication processing, will be described with reference to the flow chart illustrated in FIG. 7.

First, the operation receiving unit 30 receives an authentication request including the user identifier 44 and the authentication information 46 from the user terminal 14 (S201). Then, the information processing executing unit 40 acquires the user information 42 received from the information storage unit 32 (S202) in the processing illustrated in S201. The user information includes the user identifier 44. Then, the information processing executing unit 40 checks whether or not the term indicated by the expiration date information 48 has expired by comparing the expiration date information 48 included in the user information 42 acquired in the processing illustrated in S202 with the date and time at which the authentication request was received (S203). If the term expire (S203: Y), the information processing executing unit 40 output the information indicating that the term has expired, to an output device such as a display provided in the user terminal 14 (S204), and the processing ends.

If the term has not expired (S203: N), the information processing executing unit 40 checks whether or not the authentication information 46 received in the processing illustrated in S201 corresponds to the authentication information 46 included in the user information 42 acquired in the processing illustrated in S202 (for example, whether or not character strings of passwords correspond to each other or whether or not the positions of feature points specified on the basis of a fingerprint image correspond to each other) (S205). If they correspond to each other (S205: Y), the information processing executing unit 40 outputs, to an output device such as a display provided in the user terminal 14, the information indicating that authentication is successful and a character string corresponding to the term indicated by the expiration date information 48 corresponding to the authentication information 46 (S206). If they do not correspond to each other (S205: N), the information processing executing unit 40 outputs the information indicating that the authentication has failed to the output device such as a display provided in the user terminal 14 (S207).

Moreover, for example, in the processing illustrated in S204, the information processing executing unit 40 may output the information which requests a user to renew the authentication information 46. In addition, the operation receiving unit 30 may receive the new authentication information 46 from a user, and the information output unit 38 may perform renewal registration of the authentication information 46.

In addition, for example, in the processing illustrated in S206, the information processing executing unit 40 may output the information indicating a period until the date indicated by the expiration date information 48. In addition, the information processing executing unit 40 may output a warning message when a period until the date indicated by the expiration date information 48 is shorter than a period set beforehand. In addition, when a user logs out of the information processing system 10, the information processing executing unit 40 may output the information indicating a period until the date indicated by the expiration date information 48.

In addition, in the above-described processing example, communication of the authentication information 46 (for example, the authentication information 46 encoded by lossless encoding) may be performed between the user terminal 14 and the information processing apparatus 12. In addition, between the user terminal 14 and the information processing apparatus 12, communication of the authentication information 46 may be performed with plain text at the time of a request of registration of the user information 42, and communication of the encoded authentication information 46 (or the hashed authentication information 46) may be performed at the time of authentication processing.

Thus, in this processing example, the information processing executing unit 40 executes the authentication processing (authentication result output processing) according to the expiration date, which is indicated by the expiration date information 48 generated on the basis of the authentication information 46 stored in the information storage unit 32 so as to be associated with the user identifier 44, in response to the user's operation. In addition, the information processing executing unit 40 changes the information, which is output to an output device such as a display provided in the user terminal 14, according to whether or not the expiration date indicated by the expiration date information 48 has passed.

In addition, the invention is not limited to the above exemplary embodiment.

For example, when the operation receiving unit 30 receives a registration operation of the authentication information 46 from a user, the information generating unit 36 may generate the rule-corresponding information, which is the number-of-times information indicating the number of times (for example, n), on the basis of the received authentication information 46. In addition, the information output unit 38 may output to the information storage unit 32 the user information 42 including the user identifier 44 of the user, the received authentication information 46, and the rule-corresponding information which is the number-of-times information. In addition, when the update request of the authentication information 46 is received from the user, the information processing executing unit 40 may output the information indicating that the renewal registration is refused if the received authentication information 46 corresponds (for example, is equal) to any one of “n” latest items of the authentication information 46 registered by the user.

In addition, for example, processing executed by the information processing executing unit 40 is not limited to the authentication processing.

Specifically, for example, when the operation receiving unit 30 receives a registration operation of the authentication information 46 from a user, the information generating unit 36 may generate the rule-corresponding information, which is the authority information indicating the authority (for example, access right), on the basis of the received authentication information 46. In addition, the information output unit 38 may output to the information storage unit 32 the user information 42 including the user identifier 44 of the user, the received authentication information 46, and the rule-corresponding information which is the authority information. In addition, when the information processing executing unit 40 receives an output request of the business information associated with the authentication information 46 from the user, the information processing executing unit 40 may execute business information output processing of outputting to the user terminal 14 the business information required for the user if it is determined that the received authentication information 46 corresponds to the authentication information 46 stored in the information storage unit 32 and it is determined, on the basis of the rule-corresponding information which is the authority information, that the business information to be output is information which is permitted to be output to the user. In addition, the information processing executing unit 40 may output the information indicating the authority given to the user (or authority deprived), which is indicated by the rule-corresponding information that is the authority information, to an output device such as a display provided in the user terminal 14.

Moreover, for example, when the operation receiving unit receives a registration operation of the authentication information 46 from a user, the information generating unit 36 may generate the rule-corresponding information, which is the display state information indicating a display state of a screen (for example, the number of colors or resolution of a screen), on the basis of the received authentication information 46. In addition, the information output unit 38 may output to the information storage unit 32 the user information 42 including the received authentication information 46, the rule-corresponding information, and the like. Moreover, when the information processing executing unit receives a screen output request associated with the authentication information 46 from the user, the information processing executing unit 40 may execute business screen output processing of outputting a business screen, which is required for the user, to the user terminal 14 in a display state indicated by the display state information if the received authentication information 46 corresponds to the authentication information 46 stored in the information storage unit 32.

Moreover, for example, in the case where the information processing apparatus 12 is the information processing apparatus 12 which uses shared resources used by a plurality of users, such as a shared file server, when the operation receiving unit 30 receives a registration operation of the authentication information 46 from the user, the information generating unit 36 may generate the rule-corresponding information, which is the allocated amount information indicating the amount (for example, allocation time of a CPU, capacity of a memory or hard disk, or bandwidth of communication) of shared resources assigned to the user, on the basis of the received authentication information 46. In addition, the information output unit 38 may output to the information storage unit 32 the user information 42 including the received authentication information 46, the rule-corresponding information, and the like. In addition, when the information processing executing unit 40 receives an information processing execution request associated with the authentication information 46 from the user, the information processing executing unit 40 may execute the requested information processing using the amount of shared resources indicated by the allocated amount information if the received authentication information 46 corresponds to the authentication information 46 stored in the information storage unit 32.

Moreover, each function illustrated in FIG. 3 may not be realized in the information processing apparatus 12 which functions as a server like the above-described exemplary embodiment. For example, each function illustrated in FIG. 3 may be realized in the user terminal (client) 14.

Specifically, each function illustrated in FIG. 3 may be realized in the user terminal 14 (for example, an application program, such as a Web browser, executed in the user terminal 14), for example. For example, when the operation receiving unit 30 receives a registration operation of the authentication information 46 from the user, the information generating unit 36 may generate the rule-corresponding information, which indicates whether or not the authentication information 46 is to be input, on the basis of the received authentication information 46. In addition, the information output unit 38 may output to the information storage unit 32 the user information 42 including the received authentication information 46, the rule-corresponding information, and the like. Moreover, when the information processing executing unit 40 acquires an authentication screen including a user identifier entry form and an authentication information entry form from a Web server connected with the user terminal 14 through a communication means, such as the Internet, outputs and displays the acquired authentication screen on an output device such as a display provided in the user terminal 14, and receives from the user an operation of inputting the user identifier 44 in the user identifier entry form, the information processing executing unit 40 may output and display a character string corresponding to the authentication information 46 in the authentication information entry form if the rule-corresponding information indicates that the inputting of the authentication information 46 is not required.

In addition, each function illustrated in FIG. 3 may be realized in a communication relay, such as an RAS (remote access service) server or a proxy server. For example, when the operation receiving unit 30 receives a registration operation of the authentication information 46 from the user, the information generating unit 36 may generate the rule-corresponding information, which is the access permission information showing the information (for example, URL) indicating the location of a site the user's access to which is permitted (or not permitted), on the basis of the received authentication information 46. In addition, the information output unit 38 may output to the information storage unit 32 the user information 42 including the received authentication information 46, the rule-corresponding information, and the like. In addition, when the information processing executing unit 40 receives an access request of a site associated with the authentication information 46 from the user, the information processing executing unit 40 may output to the user terminal 14 the information on the site required for the user if it is determined that the received authentication information 46 corresponds to the authentication information stored in the information storage unit 32 and it is determined, on the basis of the access permission information, that the site access to which has been requested is a site to which the user's access is permitted.

In addition, the information storage unit 32 may store the user information 42 including the user identifier 44, the authentication information 46, and the strength information indicating the strength of the authentication information 46. In addition, the information processing executing unit 40 may execute a plurality of kinds of information processing. When the information processing executing unit 40 executes each information processing, the information processing executing unit 40 may determine a rule when executing the information processing on the basis of the strength information included in the user information 42 and execute the information processing according to the rule. Thus, the correspondence relationship between the strength and a rule may change for every information processing.

In addition, a storage device provided in the user terminal 14 may store the user identifier 44 and the authentication information 46 so as to be associated with each other. In addition, the information storage unit 32 provided in the information processing apparatus 12 may store the user identifier 44 and the rule-corresponding information so as to be associated with each other.

In addition, each function illustrated in FIG. 3 may be realized in an authentication apparatus, such as a directory server. In addition, each exemplary embodiment described above may also be applied to the distributed information processing system 10.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

What is claimed is:

1. A computer readable medium that stores a program causing a computer to perform a process comprising:
receiving an instruction from a user;
determining a rule based on a strength of authentication information of the user;
executing information processing according to the received instruction and the determined rule.

2. The computer readable medium according to claim 1, wherein the rule is relevant to effective term of the authentication information.

3. The computer readable medium according to claim 1, wherein the information processing includes outputting an authentication result of the user, and
an authentication result to be output is varied according to whether or not the authentication information expires.

4. The computer readable medium according to claim 1, wherein the information processing uses shared resource used by a plurality of users, and
shared resources assigned to the user is varied according to the strength of the authentication information.

5. The computer readable medium according to claim 1, wherein the rule is relevant to a function which is usable by the user or the authority of the user.

6. An information processing apparatus comprising:
a receiving unit that receives an instruction from a user;
a determining unit that determines a rule based on strength of authentication information of the user;
an information processing execution module that executes information processing according to the received instruction and the determined rule.

7. A method for controlling an information processing apparatus, the method comprising:
receiving an instruction from a user;
determining a rule based on a strength of authentication information of the user;
executing information processing according to the received instruction and the determined rule.
